(19) United States
(12) Patent Application Publication
(10) Pub. No.: US 2017/0180788 A1
(43) Pub. Date: Jun. 22, 2017

(54) METHOD FOR VIDEO IMAGE SWITCH AND ELECTRONIC DEVICE

(71) Applicants: Le Holdings (Beijing) Co., Ltd., Beijing (CN); LeCloud Computing Co., Ltd., Beijing (CN)

(72) Inventors: Xingyu Li, Beijing (CN); Maosheng Bai, Beijing (CN); Wei Wei, Beijing (CN)

(21) Appl. No.: 15/247,548

(22) Filed: Aug. 25, 2016

Related U.S. Application Data
(63) Continuation of application No. PCT/CN2016/087878, filed on Jun. 30, 2016.

(30) Foreign Application Priority Data
Dec. 18, 2015 (CN) 201510959287.5

(51) Int. Cl. H04N 21/438; H04N 21/442; H04N 21/24; H04N 21/2343; H04N 21/4402

(52) U.S. Cl. CPC H04N 21/4383; H04N 21/2343; H04N 21/4402; H04N 21/2402; H04N 21/44209

(57) ABSTRACT

The present application discloses a method for video image switch and an electronic device for the same. The method includes: displaying a second video signal in one-path from a server, wherein the second video signal is constituted by first video signals in multi-path, and the second video signal comprises images of the first video signals; determining a coordinate information of a selective operation and sending the coordinate information to the server, if the selective operation for the images of the first video signals is detected; and displaying the images of the first video signals returned from the server, wherein the images of the first video signals corresponds to the coordinate information. The device is used to accomplish the aforementioned method. The present application provides a variety of video images displayed simultaneously. A preferred video image can be selected to accomplish freedom of video image switch and better user experience.

### CROSS REFERENCE TO RELATED APPLICATIONS

This application is a continuation of International Application No. PCT/CN2016/087878, filed on Jun. 30, 2016, which is based upon and claims priority to Chinese Patent Application No. 201510959287.5, filed on Dec. 18, 2015, the entire contents of which are incorporated herein by reference.

### TECHNICAL FIELD

The present disclosure relates to a field of video, particular to a method for video image switch and an electronic device for video image switch.

### BACKGROUND

The broadcast console in the video industry is generally referred to the broadcast technique in the field of television program production. The broadcast console is mainly used to switch different sources of the videos so as to achieve the perfect display of the television program. For example, in a live program, there are cameras sending the video signals at different directions to the broadcast console simultaneously which are faced towards different directions. The director will select to output the video signal in one of the paths according to the required program effect.

Conventionally, to accomplish the video image switch, the switch of the video signals is operated by the careerman with professional hardware. However, the switched image may not be the image which the audience is really interested in. Thus, a solution for the program to be easily selected by the audience is urgent to be developed.

### SUMMARY

To solve these problems, the present application provides a method for video image switch and an electronic device for the same to solve the problem that in the conventional technique that the user is unable to freely switch the image of television program.

To solve the above problems, embodiments of the present application disclose a method for video image switch, including: displaying a second video signal in one-path from a server, wherein the second video signal is constituted by first video signals in multi-path, and the second video signal comprises images of the first video signals in multi-path; determining a coordinate information of a selective operation and sending the coordinate information to the server, if the selective operation for the images of the first video signals is detected; and displaying the images of the first video signals returned from the server, wherein the images of the first video signals corresponds to the coordinate information.

Embodiments of the present application provide a non-volatile computer storage medium. The computer storage medium stores computer-executable instructions, and the computer-executable instructions can carry out the method for video image switch in any one of the embodiments.

Embodiments of the present application also disclose a terminal electronic device, including a memory and a processor, wherein,

the memory is for storing one or more instructions executable by the processor, the processor is for calling the instructions stored in the memory to execute the following steps:

displaying a second video signal in one-path from a server, wherein the second video signal is constituted by first video signals in multi-path, and the second video signal comprises images of the first video signals in multi-path;

determining a coordinate information of a selective operation and sending the coordinate information to the server, if the selective operation for the images of the first video signals is detected; and

displaying the images of the first video signals returned from the server, wherein the images of the first video signals corresponds to the coordinate information.

Compared to the conventional technique, the method for video image switch and the electronic device for the same provided in the embodiments of the present application are adapted to display the first video signals in multi-path by the second video signal in one-path. Therefore, a variety of video images can be displayed simultaneously. When watching the video images, the user is able to select preferred video image to be displayed according to different requirements, such that it is favorable for accomplishing the freedom of video image switch to improve the user experience.

It should be noted that the aforementioned description and the detail described hereafter are exemplary and explanatory, and the present disclosure is not limited thereto.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method of video image switch in accordance with some embodiments.

FIG. 2 is a flow chart of a method of video image switch in accordance with some embodiments.

FIG. 3 is a flow chart of a method of video image switch in accordance with some embodiments.

FIG. 4 is a flow chart of a method of video image switch in accordance with some embodiments.

FIG. 5 is a flow chart of a method of video image switch in accordance with some embodiments.

FIG. 6 is a schematic view of a device for video image switch in accordance with some embodiments.

FIG. 7 is a schematic view of a terminal electronic device in accordance with some embodiments.

The above figures have shown a more detailed description of specific embodiments of the present disclosure, it will be there later. These figures and written description are not intended in any way to limit the scope of the concept of the present disclosure, by reference to specific embodiments but those skilled in the description of the present disclosure concept.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

In some embodiments, a second video signal in one-path is constituted by a plurality of first video signals in multi-path in a server, and the second video signal displays a plurality of images of the first video signals. A terminal apparatus displays the corresponding image of the first video signal by implementing a selective operation for the first video signal. Therefore when the user is watching the video, it is favorable for conveniently selecting the program which the user is interested in.

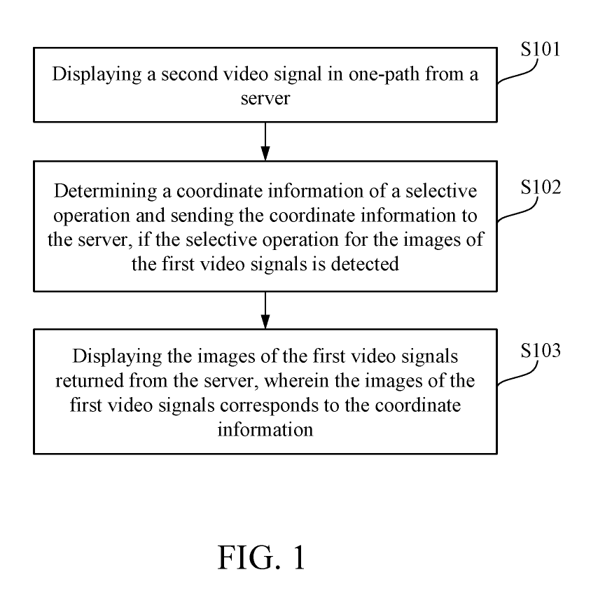

FIG. 1 is a flow chart of a method of video image switch in accordance with some embodiments. The method is applicable to the terminal apparatus such as television, computer and so on. The method includes steps S101-S103.

In the step S101, the second video signal in one-path from the server is displayed. The second video signal is constituted by the first video signals in multi-path, and the second video signal includes the images of the first video signals.

In detail, the first video signal can be a video signal from a live program or a recorded video signal. The multi-path first video signals are referred as input signals merged into the one-path second video signal. For example, some images captured by plural cameras at different positions in the studio of the live program or the recorded program can be referred to the first video signals, or some images captured or recorded by the cameras with different capturing angle in other programs can be referred to the first video signals.

In the step S102, when a selective operation for the images of the first video signals is detected, a coordinate information of the selective operation is determined and is sent to the server.

In detail, each path of the images of the first video signals has a specific displaying position in one path of the second video signal. The displaying position is the relative position of the images of the first video signal in the second video signal. When the image which the user is interested is selected by the selective operation, the position (the coordinate information) of the image of the first video signal in the second video signal is determined. According to the coordinate information, the server can accomplish the display of the first video signal corresponding to the coordinate information.

The displaying position of the image of the first video signal in the one-path second video signal is related to the size of the first video signal and the default resolution of the second video signal, wherein the size is the size of the image of the first video signal in the image of the second video signal.

The sizes of each path of the first video signals are determined according to the number of the first video signals in multi-path and the default resolution of the second video signal. In detail, the image of the second video signal is evenly divided among each path of the first video signals according to the default resolution and the number of the paths, and the sections of the divided second video signal are allocated to. In some embodiments, the image of the first video signals having longer play time or important content can be displayed in the second video signal with longer displaying time or larger size such that it is favorable for the director to monitor. For example, a first video signal including the image of the center of a conference hall, a square or a gym is more important than the other video signals, such that the one video signal can be displayed in the second video signal with larger size, and thereby it is favorable for the director to monitor whether the important first video signal is normal or not.

In some embodiments, the default resolution of the second video signal is 1080×720, and the number of the first video signals is four; thereby, the default resolution can be evenly distributed among the four first video signals. The size of each path of the first video signals can be 540×360. In some other embodiments, one of the first video signals having more important content can have a size of 1080×360, and the rest of them each has a size of 360×360. The aforementioned size arrangement for the first video signals is exemplary description, and the present disclosure is not limited thereto.

The displaying position of each of the first video signals is determined according to the size of each of the first video signals. In detail, the images of the each first video signals can be distributed on the image of the second video signal, and the coordinate information shown on the upper left corner of the image of the first video signal represents the displaying position of the first video signal.

For example, the upper left corner of the image of the second video signal is the origin, and a pair of the coordinates of the origin is (0, 0). The default resolution of the second video signal is 1080×720, and each of the four first video signals has a size of 540×360. The four first video signals are respectively distributed on the upper left, the upper right, the lower left and the lower right of the image of the second video signal. In some embodiment, the first video signal in the first path is displayed on the upper left of the image of the second video signal, and a pair of the coordinates at the upper left of the image thereof is (0, 0); the first video signal in the second path is displayed on the upper right of the image of the second video signal, and a pair of the coordinates at the upper left of the image thereof is (540, 0); the first video signal in the third path is displayed on the lower left of the image of the second video signal, and a pair of the coordinates at the upper left of the image thereof is (0, 360); and the first video signal in the fourth path is displayed on the lower right of the image of the second video signal, and a pair of the coordinates at the upper left of the image thereof is (540, 360).

When the user selects the upper left of the image of the second video signal, the pair of the coordinates (0, 0) at the upper left of the image of the first video signal in the first path is sent to the server; when the user selects the upper right of the image of the second video signal, the pair of the coordinates (540, 0) at the upper right of the image of the first video signal in the second path is sent to the server; when the user selects the lower left of the image of the second video signal, the pair of the coordinates (0, 360) at the lower left of the image of the first video signal in the third path is sent to the server; and when the user selects the lower right of the image of the second video signal, the pair of the coordinates (540, 360) at the lower right of the image of the first video signal in the fourth path is sent to the server. When the server receives the information of the coordinates, the server returns the first video signal corresponding to the coordinates to the terminal apparatus, and the first video signal is displayed.

Alternatively, the terminal apparatus obtains the coordinates of where the user clicks, and sends the coordinates to the server. The server determines the position of the image which the user selects, and thereby determining the corresponding first video signal and returning the corresponding first video signal.

For example, the upper left corner of the image of the second video signal is the origin, and a pair of the coordinates of the origin is (0, 0). The default resolution of the second video signal is 1080×768, and each of the four first video signals has a size of 540×384. The four first video signals are respectively distributed on the upper left, the upper right, the lower left and the lower right of the image of the second video signal. the first video signal in the first path is displayed on the upper left of the image of the second video signal, and a pair of the coordinates at the upper left of the image thereof is (0, 0); the first video signal in the second path is displayed on the upper right of the image of the second video signal, and a pair of the coordinates at the upper left of the image thereof is (540, 0); the first video signal in the third path is displayed on the lower left of the image of the second video signal, and a pair of the coordinates at the upper left of the image thereof is (0, 384); and the first video signal in the fourth path is displayed on the lower right of the image of the second video signal, and a pair of the coordinates at the upper left of the image thereof is (540, 384).

The pair of the coordinates of the position where the user clicks is (560, 390). The terminal apparatus obtains the pair of the coordinates and sends it to the server. The server determines the position where the user clicks is at the lower right of the image according to the coordinates (560, 390), and thereby the server determines the first video signal in the fourth path corresponding to the lower right of the image and returns the first video signal.

In the step S103, displaying the image of the first video signal corresponding to the coordinates returned from the server.

According to the coordinates of the image of the first video signal which is determined, the first video signal corresponding to the coordinates is obtained, and the image of the first video signal is displayed.

In this embodiment, the first video signals in multi-path are constituted into the second video signal in one-path. Therefore, a variety of video images can be displayed simultaneously. When watching the video images, the user is able to select preferred video image to be displayed according to different requirements, such that it is favorable for accomplishing the freedom of video image switch to improve the user experience.

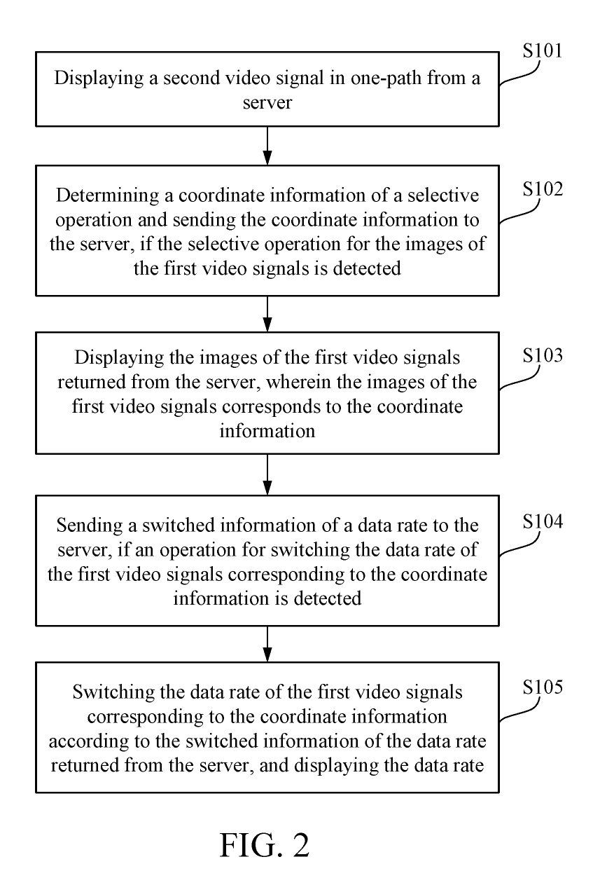

In one embodiment, as shown in FIG. 2, the method for video image switch further includes two steps S104 and S105.

In the step S104, if an operation for switching a data rate of the first video signal corresponding to the coordinates is detected, sending a switched information of a data rate to the server.

A data rate is an amount of digital data that is conveyed or processed per unit of time. Under the same resolution, the larger the data rate of the video is and the smaller of the compression ratio is, the higher of the image quality is. For example, the data rate of the image of the first video signal has standard definition (SD), high definition (HD) and super definition (SPD). The user can select desired data rate according to their necessary. When the video is required to have high resolution and higher clarity, the data rate can be selected to HD or SPD. When the video is required to be fluent, the data rate can be selected to SD.

In the step S105, switching the data rate of the first video signals corresponding to the coordinate information according to the switched information of the data rate returned from the server, and displaying the data rate.

According to the data rate selected by the user, the image of the video signal corresponding to the selected data rate is displayed.

In this embodiment, according to different requirement of the image quality, the user is able to select the required video image to display. For example, when the user wants to see HD video, the user can select to display the image having higher data rate. When the user wants to see fluent video, the user can select to display the image having lower data rate. Thus, it is favorable for the user experience.

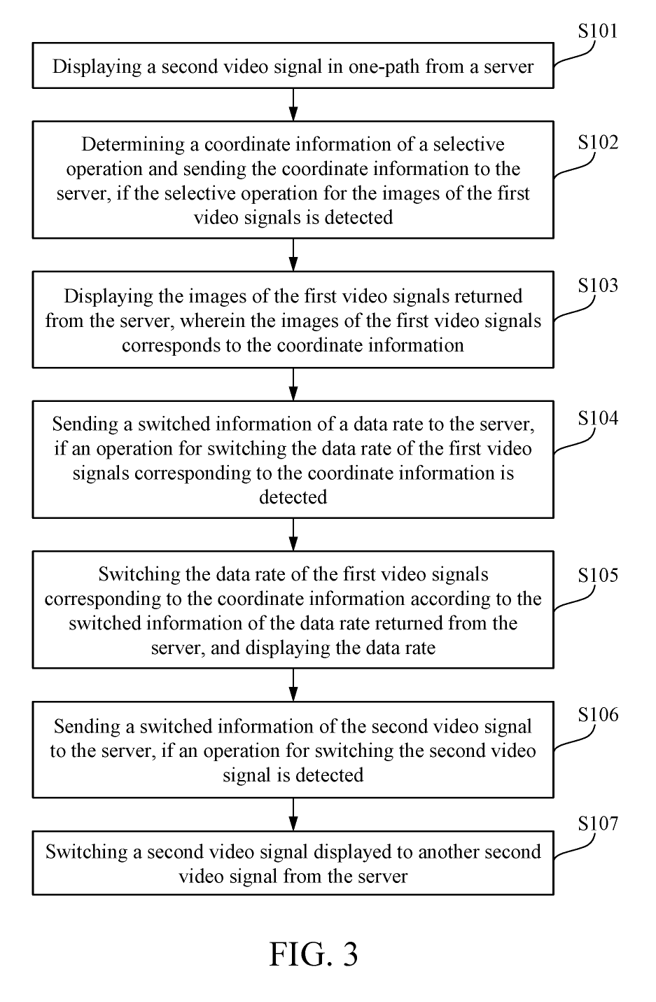

In one embodiment, as shown in FIG. 3, the method for video image switch further includes two steps S106 and S107.

In the step S106, when an operation for switching the second video signal is detected, sending a switched information of the second video signal to the server.

The first video signals in multi-path constitute into the second video signal in one-path, and multiple images of the first video signals are displayed in the second video signal. When the quantity of the first video signal is more than the maximum quantity of the images which can be displayed in the second video signal in one-path, there can be multiple second video signals. When the user is not interested in one of the second video signals which is displaying, the user is able to turn page to switch to another second video signal.

For example, a second video signal in one-path is capable of displaying at most four first video signals, and there are a total of twelve first video signals. In such a case, since it is difficult to display all first video signals in single second video signal, there are multiple second video signals such as three second video signals to accomplish the display of twelve first video signals. For example, the second video signal in first path can be adapted to display the first video signals in the first path through the fourth path; the second video signal in second path can be adapted to display the first video signals in the fifth path through the eighth path; and the second video signal in third path can be adapted to display the first video signals in the ninth path through the twelfth path. When the second video signal in the first path is displayed and the user is interested in the image of the first video signal in the eighth path, the user is able to turn page to view the second video signal in the second path and then select the first video signal in the eighth path.

In the step S107, switching a displayed second video signal to another second video signal from the server.

When the user is not interested in the first video signals which are displaying in a second video signal, the user turns page to the second video signal in the next path, and the second video signal which is displaying is switched to the second video signal in the next path in the server. The user selects the interested first video signal in the second video signal in the next path. If the user is still not interested in the video signals displayed in the second video signal, the user can turn page again until the video which the user is interested is found.

In this embodiment, more images of first video signals are displayed by providing multiple second video signals. The user can turn page to select the interesting video image. Thus, it is favorable for improving the selection of user and the convenient of operation.

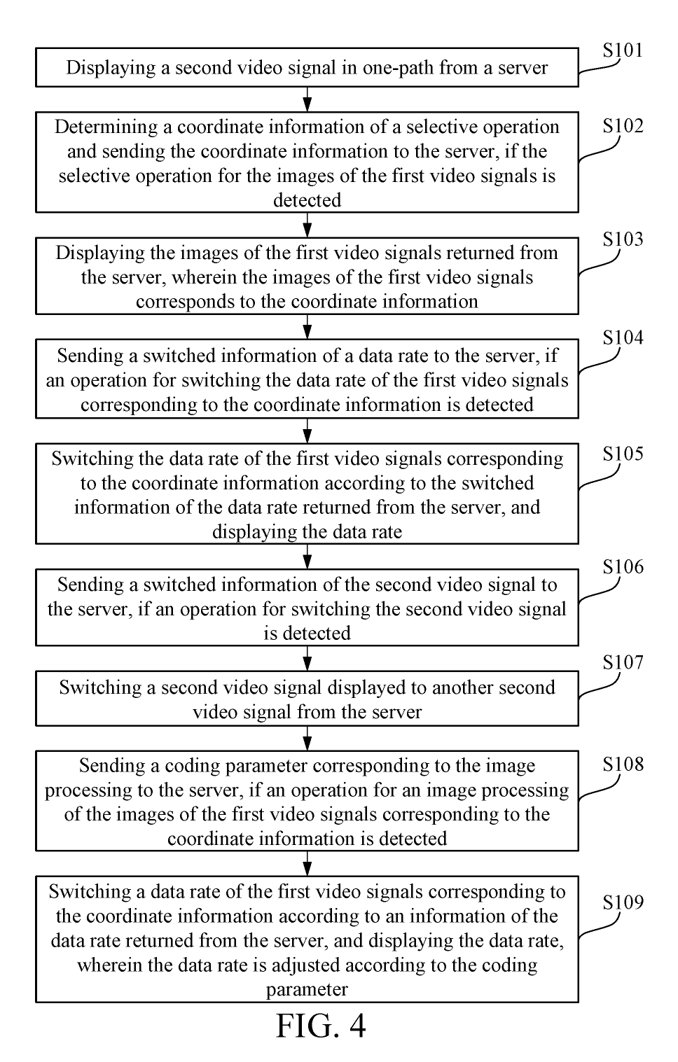

In one embodiment, as shown in FIG. 4, the method for video image switch further includes two steps S108 and S109.

In the step S108, if an operation for an image processing of the images of the first video signals corresponding to the coordinates is detected, sending a coding parameter corresponding to the image processing to the server.

When the user views the interesting first video signal, the user is also able to implement an image processing on the images which is displaying, such as sharpening image, denoising image, adding logo on the image and so on. According to the requirement, the user is able to select one or more image processing operations to improve the quality of the image which is displaying. According to the image processing selected by the user, a coding parameter corresponding to the selected image processing is sent to the server.

In the step S109, switching a data rate of the first video signals corresponding to the coordinate information according to an information of the data rate returned from the server, and displaying the data rate, wherein the data rate is adjusted according to the coding parameter.

The server adjusts the data rate of the image of the first video signal according to the coding parameter corresponding to the selected image processing, and then returns the adjusted data rate to the terminal apparatus. The terminal apparatus switches the first video signal to the image having the adjusted data rate and displays the image such that a video image satisfying the user's requirement is obtained.

In this embodiment, the user is able to implement image processing on the video image which is displaying such that it is favorable for improving the user experience and the freedom of selection.

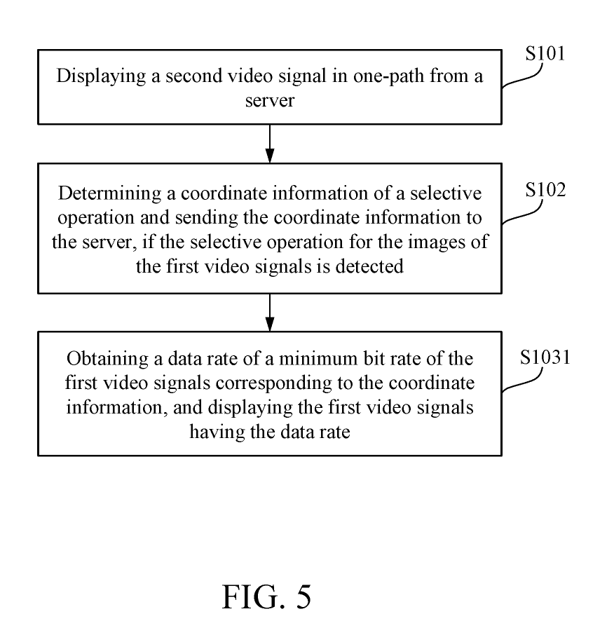

In one embodiment, as shown in FIG. 5, the step S103 can further includes a step S1031.

In the step S1031, obtaining a data rate of a minimum bit rate of the first video signals corresponding to the coordinate information, and displaying the first video signals having the data rate.

For the user's experience and ensuring the fluent of the video, the first video signal is displayed with the minimum data rate as the top priority.

The following is a device of an embodiment of the present application, and this device is adapted for implementing the method in the aforementioned embodiments.

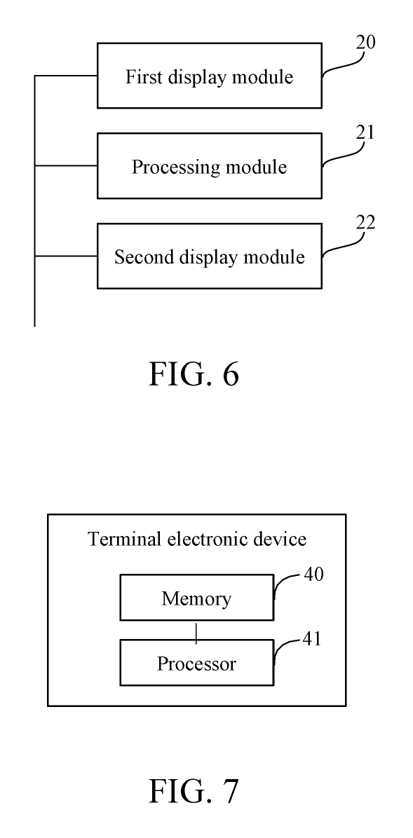

FIG. 6 shows a device for video image switch located on a side of the terminal apparatus. The device includes:

a first display module 20 for displaying a second video signal in one-path from a server, wherein the second video signal is constituted by first video signals in multi-path, and the second video signal comprises images of the first video signals in multi-path;

a processing module 21 for determining a coordinate information of a selective operation and sending the coordinate information to the server, if the selective operation for the images of the first video signals is detected; and

a second display module 22 for displaying the images of the first video signals returned from the server, wherein the images of the first video signals corresponds to the coordinate information.

In one embodiment, the device further includes:

a first outputting module for sending a switched information of a data rate to the server, if an operation for switching the data rate of the first video signals corresponding to the coordinate information is detected; and

a first switching module for switching the data rate of the first video signals corresponding to the coordinate information according to the switched information of the data rate returned from the server, and displaying the data rate.

In one embodiment, the device further includes:

a second outputting module for sending a switched information of the second video signal to the server, if an operation for switching the second video signal is detected; and

a second switching module for switching a second video signal displayed to another second video signal from the server.

In one embodiment, the device further includes:

a third outputting module for sending a coding parameter corresponding to the image processing to the server, if an operation for an image processing of the images of the first video signals corresponding to the coordinate information is detected; and

a third switching module for switching a data rate of the first video signals corresponding to the coordinate information according to an information of the data rate returned from the server, and displaying the data rate, wherein the data rate is adjusted according to the coding parameter.

In one embodiment, the second display module 22 includes:

a sub-display module for obtaining a data rate of a minimum bit rate of the first video signals corresponding to the coordinate information, and displaying the first video signal having the data rate.

Moreover, the embodiments of the present application can accomplish the aforementioned functional module by hardware processor.

The aforementioned embodiments are described for the purpose of explanation. The element for displaying can be a physical element or mot; that is, the element for displaying can be located on a specific position or distrusted among plural network units. Many modifications and variations are possible in view of part or all of the above teachings, to thereby enable others skilled in the art to best utilize the disclosure and various embodiments with various modifications as are suited to the particular use contemplated.

In addition, the method according to the disclosure may also be implemented by a computer program executed by the CPU. The computer program may be stored in a readable storage medium. When the computer program is executed by the CPU, the method of the present application is executed.

In addition, the aforementioned steps of the method and the units in the system can use a controller and storage to make the controller accomplish the functions of the computer program stored in a readable storage medium described in the aforementioned steps and the units in the system.

In addition, it should be understood that the computer readable storage devices (such as memory) may be volatile memory or nonvolatile memory, or can include volatile memory and nonvolatile memory both. By way of example and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), the RAM can act as external cache memory. By way of example and not limitation, RAM is available in many forms available, such as synchronous RAM (DRAM), dynamic RAM (DRAM), synchronous DRAM (SDRAM), double data rate SDRAM (DDR SDRAM), Enhanced SDRAM (ESDRAM), synchronous link DRAM (SLDRAM) and direct Rambus RAM (DRRAM). The disclosed aspects of the storage device is intended to include, but not limited to, these and other suitable types of memory.

An embodiment of the present application provides a non-volatile computer storage medium. The computer storage medium stores computer-executable instructions, and the computer-executable instructions can carry out the method for video image switch in any one of the embodiments.

As an example, as shown in FIG. 7, an embodiment of the present application discloses a terminal electronic device including a memory 40 and a plurality of processors 41, wherein,

the memory 40 is for storing one or more instructions executable by the processor.

the processor 41 is for calling the instructions stored in the memory to execute the following steps:

displaying a second video signal in one-path from a server, wherein the second video signal is constituted by first video signals in multi-path, and the second video signal comprises images of the first video signals in multi-path;

determining a coordinate information of a selective operation and sending the coordinate information to the server, if the selective operation for the images of the first video signals is detected; and

displaying the images of the first video signals returned from the server, wherein the images of the first video signals corresponds to the coordinate information.

Further, for the display of the one-path second video signal from the server, the second video signal is constituted by the first video signals in multi-path, including the images of the first video signals. The processor 41 is specifically adapted for: determining a size of each the first video signal according to a number of the first video signal and a default resolution of the second video signal; determining a displaying position of each of the first video signals according to the size of each of the first video signals; and displaying the second video signal according to the displaying position.

Further, the processor 41 is adapted for: sending a switched information of a data rate to the server, if an operation for switching the data rate of the first video signals corresponding to the coordinate information is detected; and switching the data rate of the first video signals corresponding to the coordinate information according to the switched information of the data rate returned from the server, and displaying the data rate.

Further, the processor 41 is adapted for: sending a switched information of the second video signal to the server, if an operation for switching the second video signal is detected; and switching a second video signal displayed to another second video signal from the server.

Further, the processor 41 is adapted for: sending a coding parameter corresponding to the image processing to the server, if an operation for an image processing of the images of the first video signals corresponding to the coordinate information is detected; and switching a data rate of the first video signals corresponding to the coordinate information according to an information of the data rate returned from the server, and displaying the data rate, wherein the data rate is adjusted according to the coding parameter.

Further, for displaying the image of the first video signal corresponding to the coordinate information returned from the server, the processor 41 is specifically adapted for: obtaining a data rate of a minimum bit rate of the first video signals corresponding to the coordinate information, and displaying the first video signals having the data rate.

The processor 41 is exemplary in FIG. 7. The apparatus for performing a processing method for the operation of listed items can include: an input device and an output device.

The processor 41, the memory 40, the input device and the output device can be connected to each other via a bus or other members for electrical connection. In FIG. 7, they are connected to each other via the bus in this embodiment.

The memory 40 is one kind of non-volatile computer-readable storage mediums applicable to store non-volatile software programs, non-volatile computer-executable programs and modules; for example, the program instructions and the function modules (the first display module 20, the processing module 21 and the second display module 22 in FIG. 6) corresponding to the method for video image switch in the embodiments are respectively a computer-executable program and a computer-executable module. The processor 41 executes function applications and data processing of the server by running the non-volatile software programs, non-volatile computer-executable programs and modules stored in the memory 40, and thereby the methods for video image switch in the aforementioned embodiments are achievable.

The memory 40 can include a program storage area and a data storage area, wherein the program storage area can store an operating system and at least one application program required for a function; the data storage area can store the data created according to the usage of the device for video image switch. Furthermore, the memory 40 can include a high speed random-access memory, and further include a non-volatile memory such as at least one disk storage member, at least one flash memory member and other non-volatile solid state storage member. In some embodiments, the memory 40 can have a remote connection with the processor 41, and such memory can be connected to the device for video image switch by a network. The aforementioned network includes, but not limited to, internet, intranet, local area network, mobile communication network and combination thereof.

The input device can receive digital or character information, and generate a key signal input corresponding to the user setting and the function control of the device for video image switch. The output device can include a displaying unit such as screen.

The one or more modules are stored in the memory 40. When the one or more modules are executed by one or more processor 41, the method for video image switch disclosed in any one of the embodiments is performed.

The technical feature of the terminal apparatus, the function of each functional module and the relationships among the functional modules correspond to the embodiments described in FIGS. 1 to 5. Any deficiencies in the illustration can be referred to FIGS. 1 to 5.

The electronic device in the embodiments of the present application is presence in many forms, and the electronic device includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic device having a data exchange function.

One skilled in the art will understand that a combination here of the various illustrative logical blocks described in this disclosure, modules, circuits, and algorithm steps may be implemented as electronic hardware, computer software, or both. To clearly illustrate the hardware and software of this interchangeability, various illustrative components, blocks, modules, circuits, and steps of their functionality a general description. This function is implemented as software or hardware is implemented as depending on the application and design constraints imposed to the entire system. Those skilled in the art can for each particular application in a variety of ways to achieve the function, but such implementation decisions should not be interpreted as causing a departure from the scope of the present disclosure.

Various combination herein is disclosed as illustrative logical blocks, modules and circuits can be designed to perform the functions described herein the following components implemented or performed: a general purpose processor, a digital signal processor (DSP) any combination of application specific integrated circuit (ASIC), field programmable gate array (FPGA) or other programmable logic device, discrete gate or transistor logic, discrete hardware components, or these components. A general purpose processor may be a microprocessor, but in the alternative, the processor may be any conventional processor, controller, microcontroller, or state machine. A processor may also be implemented as a combination of computing devices, e.g. a combination of a DSP and a microprocessor, a plurality of microprocessors, one or more microprocessors in conjunction with a DSP core, or any other such configuration.

The steps of a method disclosed herein in combination as described or algorithm directly in hardware, a software module executed by a processor in the combination of the two, or. A software module may reside in RAM memory, flash memory, ROM memory, EPROM memory, EEPROM memory, registers, hard disk, removable disk, CD-ROM, known in the art, or any other form of storage medium. An exemplary storage medium is coupled to the processor such that the processor can read information from the storage medium or write information to, the storage medium. In the alternative, the storage medium may be integral to the processor. Processor and the storage medium may reside in an ASIC. ASIC may reside in a user terminal. In one alternative, the processor and the storage medium may reside as discrete components in a user terminal.

In one or more exemplary designs, the functions may be implemented in hardware, software, firmware, or any combination thereof. If implemented in software, the functions may be used as one or more instructions or code stored on a computer readable medium or transmitted by a computer-readable medium. Computer-readable media includes both computer storage media and communication media, and communication media includes the help of a computer program from one location to another location in any medium. A storage media may be able to be accessed by a general purpose or special purpose computer any available media. By way of example and not limitation, such computer-readable media can comprise RAM, ROM, EEPROM, CD-ROM or other optical disk storage, magnetic disk storage or other magnetic storage devices, or can be used to carry or store instruction form desired program code or data structures and that can be general purpose or special purpose computer or a general-purpose or special-purpose processor to access any other medium. Also, any connection is properly termed a computer-readable medium. For example, if you use a coaxial cable, fiber optic cable, twisted pair, digital subscriber line (DSL) or wireless technologies such as infrared, radio, and microwave from a website, server, or other remote source, the above coaxial cable, fiber optic cable, twisted pair, DSL, or as the first infrared, radio, and microwave wireless technologies are included in the definition of the medium. As used herein, disk and CD-ROM includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows an exemplary embodiment of the present disclosure, it should be noted, without departing from the scope defined by the claims of the disclosure premise, various changes and modifications can be made. A method according to an embodiment of the disclosure described herein required functions, steps and/or actions need not be performed in any particular order. Furthermore, although elements of the present disclosure may be described or claimed in the individual form, but one can imagine more unless explicitly restricted to the singular.

It should be understood that the singular forms “a”, “an”, and “the” used in this application and the claims are intended to include most forms unless the context clearly dictates otherwise. It should also be understood that the term “and/or” used herein means and includes any or all possible combinations of one or more of the associated listed items.

The serial numbers listed in the embodiments of the present application are only for convenient description, and do not represent the pros and cons of the embodiments.

One skilled in the art can realize that some or all embodiments can be enabled by hardware or by instructing hardware by a computer program. Said computer program can be stored in a readable computer medium such as read only memory, diskette and compact disk.

Although described above with reference to FIG been described in accordance with various embodiments of the present disclosure, those skilled in the art would understand, the various embodiments of the present disclosure is made, may also departing from the present disclosure is not based on make a variety of improvements. Accordingly, the scope of the disclosure should be determined by the appended claims contents of the book claims.

What is claimed is:

1. A method for video image switch, applicable to a terminal, comprising:
displaying a second video signal in one-path from a server, wherein the second video signal is constituted by first video signals in multi-path, and the second video signal comprises images of the first video signals in multi-path;
determining a coordinate information of a selective operation and sending the coordinate information to the server, if the selective operation for the images of the first video signals is detected; and
displaying the images of the first video signals returned from the server, wherein the images of the first video signals corresponds to the coordinate information.

2. The method according to claim 1, wherein the displaying the second video signal in one-path from the server comprises:
determining a size of each of the first video signals according to a number of the first video signals and a default resolution of the second video signal;
determining a displaying position of each of the first video signals according to the size of each of the first video signals; and
displaying the second video signal according to the displaying position.

3. The method according to claim 1, further comprising:
sending a switched information of a data rate to the server, if an operation for switching the data rate of the first video signals corresponding to the coordinate information is detected; and
switching the data rate of the first video signals corresponding to the coordinate information according to the switched information of the data rate returned from the server, and displaying the data rate.

4. The method according to claim 1, further comprising:
sending a switched information of the second video signal to the server, if an operation for switching the second video signal is detected; and
switching a second video signal displayed to another second video signal from the server.

5. The method according to claim 1, further comprising:
sending a coding parameter corresponding to the image processing to the server, if an operation for an image processing of the images of the first video signals corresponding to the coordinate information is detected; and
switching a data rate of the first video signals corresponding to the coordinate information according to an information of the data rate returned from the server, and displaying the data rate, wherein the data rate is adjusted according to the coding parameter.

6. The method according to claim 1, wherein the displaying the images of the first video signals returned from the server comprises:
obtaining a data rate of a minimum bit rate of the first video signals corresponding to the coordinate information, and displaying the first video signals having the data rate.

7. A non-volatile computer storage medium storing a computer-executable instruction, and the computer-executable instruction being for:
displaying a second video signal in one-path from a server, wherein the second video signal is constituted by first video signals in multi-path, and the second video signal comprises images of the first video signals in multi-path;
determining a coordinate information of a selective operation and sending the coordinate information to the server, if the selective operation for the images of the first video signals is detected; and
displaying the images of the first video signals returned from the server, wherein the images of the first video signals corresponds to the coordinate information.

8. An electronic device, comprising:
at least one processor; and
a memory communicatively connected to the at least one processor, wherein the memory stores an instruction executable by the at least one processor, the at least one processor is for calling the instruction to execute a method comprising:
displaying a second video signal in one-path from a server, wherein the second video signal is constituted by first video signals in multi-path, and the second video signal comprises images of the first video signals in multi-path;
determining a coordinate information of a selective operation and sending the coordinate information to the server, if the selective operation for the images of the first video signals is detected; and
displaying the images of the first video signals returned from the server, wherein the images of the first video signals corresponds to the coordinate information.

9. The non-volatile computer storage medium according to claim 7, wherein the displaying the second video signal in one-path from the server comprises:
determining a size of each of the first video signals according to a number of the first video signals and a default resolution of the second video signal;
determining a displaying position of each of the first video signals according to the size of each of the first video signals; and
displaying the second video signal according to the displaying position.

10. The non-volatile computer storage medium according to claim 7, wherein the computer-executable instruction is further for:
sending a switched information of a data rate to the server, if an operation for switching the data rate of the first video signals corresponding to the coordinate information is detected; and
switching the data rate of the first video signals corresponding to the coordinate information according to the switched information of the data rate returned from the server, and displaying the data rate.

11. The non-volatile computer storage medium according to claim 7, wherein the computer-executable instruction is further for:
sending a switched information of the second video signal to the server, if an operation for switching the second video signal is detected; and
switching a second video signal displayed to another second video signal from the server.

12. The non-volatile computer storage medium according to claim 7, wherein the computer-executable instruction is further for:
sending a coding parameter corresponding to the image processing to the server, if an operation for an image processing of the images of the first video signals corresponding to the coordinate information is detected; and
switching a data rate of the first video signals corresponding to the coordinate information according to an information of the data rate returned from the server, and displaying the data rate, wherein the data rate is adjusted according to the coding parameter.

13. The non-volatile computer storage medium according to claim 7, wherein the displaying the images of the first video signals returned from the server comprises:
obtaining a data rate of a minimum bit rate of the first video signals corresponding to the coordinate information, and displaying the first video signals having the data rate.

14. The electronic device according to claim 8, wherein the s displaying the second video signal in one-path from the server comprises:
determining a size of each of the first video signals according to a number of the first video signals and a default resolution of the second video signal;
determining a displaying position of each of the first video signals according to the size of each of the first video signals; and
displaying the second video signal according to the displaying position.

15. The electronic device according to claim 8, wherein the at least one processor further executes:
sending a switched information of a data rate to the server, if an operation for switching the data rate of the first video signals corresponding to the coordinate information is detected; and
switching the data rate of the first video signals corresponding to the coordinate information according to the switched information of the data rate returned from the server, and displaying the data rate.

16. The electronic device according to claim 8, wherein the at least one processor further executes:
sending a switched information of the second video signal to the server, if an operation for switching the second video signal is detected; and
switching a second video signal displayed to another second video signal from the server.

17. The electronic device according to claim 8, wherein the at least one processor further executes:
sending a coding parameter corresponding to the image processing to the server, if an operation for an image processing of the images of the first video signals corresponding to the coordinate information is detected; and
switching a data rate of the first video signals corresponding to the coordinate information according to an information of the data rate returned from the server, and displaying the data rate, wherein the data rate is adjusted according to the coding parameter.

18. The electronic device according to claim 8, wherein the displaying the images of the first video signals returned from the server comprises:
obtaining a data rate of a minimum bit rate of the first video signals corresponding to the coordinate information, and displaying the first video signals having the data rate.
